(19) United States
(12) Patent Application Publication
(10) Pub. No.: US 2010/0060914 A1
(43) Pub. Date: Mar. 11, 2010

(54) IMAGE FORMING APPARATUS TO HAVE PROCESSING APPARATUS AND PROCESSING METHOD OF IMAGE FORMING APPARATUS

(75) Inventor: Young-min Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/429,235

(22) Filed: Apr. 24, 2009

(30) Foreign Application Priority Data
Sep. 9, 2008 (KR) 2008-0088822

(51) Int. Cl. H04N 1/60; G06F 3/12

(52) U.S. Cl. 358/1.9; 358/1.13

(57) ABSTRACT

An image forming apparatus to have a processing apparatus includes a plurality of main developing apparatuses to form an image on a printing medium, an auxiliary developing apparatus to form an image on the printing medium using at least one developer different from developers used in the plurality of main developing apparatuses, a processing apparatus to perform a processing operation at the printing medium, and a control portion to control the main developing apparatuses and the auxiliary developing apparatus to form the images on the printing medium and to control the processing apparatus to form a printing medium processing region at which the processing operation is performed. The control portion estimates a size or area the printing medium processing region according to a processing condition, and does not control the auxiliary developing apparatus to form the image on at least some region of the estimated size or area of the printing medium processing region.

### CROSS-REFERENCE TO RELATED APPLICATIONS

This application claims the benefit under 35 U.S.C. §119(a) from Korean Patent Application No. 2008-88822 filed Sep. 9, 2008 in the Korean Intellectual Property Office, the disclosure of which is incorporated herein by reference in its entirety.

### BACKGROUND

1. Field of the General Inventive Concept

The present general inventive concept relates to an image forming apparatus. More particularly, the present general inventive concept relates to an image forming apparatus to have a processing apparatus and a processing method usable with the image forming apparatus.

2. Description of the Related Art

Generally, an image forming apparatus having a processing apparatus includes an image forming unit to form images on a printing medium and the processing apparatus to perform a processing operation with respect to printing media having been printed.

The processing apparatus performs post-printing operations, that is, processing operations, such as binding, folding, stapling, punching operations, etc., with respect to the printing media having been printed. Here, the binding operation is an operation to apply paste on some portion of each of a plurality of printing media and to assemble the printing media like a book or other bound publication. The folding operation is an operation to fold a portion of the printing medium. The stapling operation is an operation to hold or fasten a plurality of printing media together firmly using a stapling mechanism. The punching operation is an operation to form a hole or holes on the printing medium. Processing apparatuses to perform post-printing operations as described above are well known.

Also, image forming apparatuses may be classified as a mono image forming apparatus to form images using mono color developer (generally, black developer), a color image forming apparatus to form color images using four color developers, and a multi-color image forming apparatus to form color images using the four color developers and auxiliary developer such as white developer, etc.

The present general inventive concept relates to a multi-color image forming apparatus to have a processing apparatus and operations to form images at regions of a printing medium at which a processing operation is performed.

### SUMMARY

The present general inventive concept provides an image forming apparatus to have a processing apparatus capable of reducing the usage amount of auxiliary developer, and a processing method of the image forming apparatus.

Additional aspects and utilities of the present general inventive concept will be set forth in part in the description which follows and, in part, will be obvious from the description, or may be learned by practice of the general inventive concept.

Embodiments of the present general inventive concept may be achieved by providing an image forming apparatus to have a processing apparatus, which may include a plurality of main developing apparatuses to form a first image on a printing medium, an auxiliary developing apparatus to form an additional image on the printing medium using at least one developer different from developers used in the plurality of main developing apparatuses, a processing apparatus to perform a processing operation on the printing medium; and a control portion to control the main developing apparatuses and the auxiliary developing apparatus to form selectively the first image and the additional image on the printing medium and to control the processing apparatus to form a processing region on the printing medium at which the processing operation is performed, wherein the control portion may control the auxiliary developing apparatus to not form the image on at least some region around the processing region.

The processing condition may include a printing coverage. If the printing coverage of the image that is going to be printed is larger than a reference printing coverage, the control portion may control the auxiliary developing apparatus to not form the image on the processing region, and if the printing coverage of the image that is going to be printed is the same as or smaller than the reference printing coverage, the control portion controls the auxiliary developing apparatus to form the image on the processing region.

The auxiliary developing apparatus may form white images, light color images or transparent images.

The processing apparatus may be formed to perform at least one operation among binding, folding, stapling, and punching operations. The processing region may be a region of the printing medium at which the processing apparatus performs at least one operation among the binding, folding, stapling, and punching operations. When the image is not formed on the processing region, the control portion does not control a light scanning device of the auxiliary developing apparatus to form an electrostatic latent image on a region of a photosensitive medium corresponding to the processing region

Embodiments of the present general inventive concept may also be achieved by providing a processing method for an image forming apparatus to have a processing apparatus including receiving an input of a processing condition, comparing a printing coverage of an image that is going to be printed with a reference printing coverage, estimating if the printing coverage of the image that is going to be printed is larger than the reference printing coverage a size or area of a processing region of a printing medium at which the inputted processing operation is to be performed, forming the image on the printing medium except the processing region, and performing the processing operation on the printing medium.

If the printing coverage of the image that is going to be printed is the same as or smaller than the reference printing coverage, the processing method may include, forming the image on the printing medium, and performing the processing operation on the printing medium. The receiving the input of the processing condition may include inputting the processing condition through an input/output portion of the image forming apparatus or inputting the processing condition through a host connected with the image forming apparatus.

The processing condition may include at least one among binding, folding, stapling, and punching operations as the kind of the processing operation.

The processing condition may include an automatic print mode and a manual print mode as a print condition of the processing region. If the manual print mode is set in a print condition, when the printing coverage of the image that is going to be printed is larger than the reference printing coverage, a user selects whether to allow the image to be formed on the processing region.

When the processing condition is at least one among the stapling or punching operation, a print condition of the processing region may include that the image is not formed on a partial region of the processing region.

Embodiments of the present general inventive concept may also be achieved by providing an image forming apparatus including a main developing apparatus to form a first image on a printing medium, an auxiliary developing apparatus to form an additional image on the printing medium, a processing apparatus to perform processing operations on the print medium, a processing region on the print medium in which to perform the processing operations, and a control portion to output a selecting signal if a mode is selected so that a user can determine whether to allow the control portion to form the additional image on the processing region. Processing operations include at least one among binding, folding, stapling, and punching operations.

Embodiments of the present general inventive concept may also be achieved by providing a method of forming an image in an image forming apparatus, including receiving an input of a processing condition to be processed on a printing medium, receiving an input of an image to be printed on a printing medium, comparing a size of a printing coverage of the image to be printed on the printing medium with a size of a reference printing coverage, and controlling the developing of the image on a processing region based on the result of the comparison between the size of the printing coverage and the size of the reference printing coverage.

If the size of the printing coverage is larger than the reference printing coverage, the image is not developed on the processing region. If the size of the printing coverage is the same as or smaller than the reference printing coverage, the image is developed on the processing region.

Embodiments of the present general inventive concept may also be achieved by providing a computer readable medium to contain computer-readable codes to perform a method in an image forming apparatus to have a processing apparatus, the method receiving an input of a processing condition, comparing a printing coverage of an image that is going to be printed with a reference printing coverage, estimating if the printing coverage of the image that is going to be printed is larger than the reference printing coverage a size or area of a processing region of a printing medium at which the inputted processing operation is to be performed, forming the image on the printing medium except the processing region, and performing the processing operation on the printing medium.

Other objects, advantages and salient features of the preset general inventive concept will become apparent from the following detailed description, which, taken in conjunction with the annexed drawings, discloses example embodiments of the preset general inventive concept.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a sectional view schematically illustrating an image forming apparatus to have a processing apparatus according to an embodiment of the present general inventive concept;

FIG. 2 is a functional block diagram illustrating the image forming apparatus to have a processing apparatus of FIG. 1;

FIG. 3 is a view illustrating a processing conditions select menu usable with the image forming apparatus to have a processing apparatus of FIG. 1;

FIG. 4A is a view illustrating a printing medium that is going to be bound according to an embodiment of the present general inventive concept;

FIG. 4B is a view illustrating a printing medium that is going to be fold according to an embodiment of the present general inventive concept;

FIG. 4C is a view illustrating a printing media that is stapled according to an embodiment of the present general inventive concept;

FIG. 4D is a view illustrating a printing media that is punched according to an embodiment of the present general inventive concept;

FIG. 5A is a view illustrating a printing medium that is stapled and has no images in only two regions adjacent to two staples according to an embodiment of the present general inventive concept;

FIG. 5B is a view illustrating a printing medium that is punched and has no images in only two regions adjacent to two punching holes according to an embodiment of the present general inventive concept; and

FIG. 6 is a flow chart illustrating a processing method of an image forming apparatus according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description, such as a detailed construction and elements thereof, are provided to assist in a comprehensive understanding of the present general inventive concept. Thus, it is apparent that the present general inventive concept may be carried out without those defined matters. Also, well-known functions or constructions are omitted to provide a clear and concise description of exemplary embodiments of the present general inventive concept.

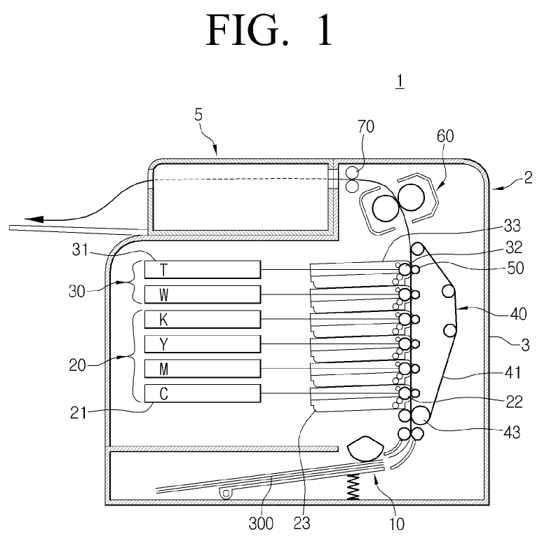

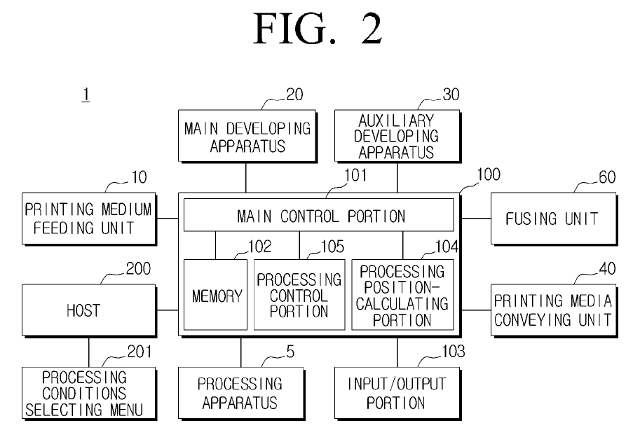

FIG. 1 is a sectional view schematically illustrating an image forming apparatus 1 to have a processing apparatus according to an embodiment of the present general inventive concept. FIG. 2 is a functional block diagram illustrating the image forming apparatus 1 to have a processing apparatus of FIG. 1.

Referring to FIGS. 1 and 2, the image forming apparatus 1 to have a processing apparatus according to an embodiment of the present general inventive concept may include an image forming unit 2 and a processing apparatus 5.

The image forming unit 2 forms images corresponding to print data received from a host 200 onto a printing medium 300. The image forming unit 2 may include a main case 3, a printing medium feeding unit 10, a plurality of main developing apparatuses 20, an auxiliary developing apparatus 30, a printing media conveying unit 40, a plurality of transfer media 50, a fusing unit 60, a discharging unit 70, and a control portion 100.

The main case 3 forms an outer appearance of the image forming apparatus 1. Components including the printing medium feeding unit 10, the plurality of main developing apparatuses 20, the auxiliary developing apparatus 30, the printing media conveying unit 40, the plurality of transfer media 50, the fusing unit 60, the discharging unit 70, and the control portion 100 are disposed inside the main case 3.

The printing medium feeding unit 10 stores predetermined sheets of printing media 300, and picks up the stored printing media 300 one by one to feed the printing media 300 to the printing media conveying unit 40. The printing medium feeding unit 10 may be formed to store and/or feed various kinds of printing media 300.

The plurality of main developing apparatuses 20 forms images corresponding to the print data on the printing medium 300 fed from the printing medium feeding unit 10 using developer. In this embodiment, the plurality of main developing apparatuses 20 includes four main developing apparatuses. Each of the plurality of main developing apparatuses 20 may include a light scanning unit 21, a photosensitive medium 22, and a developing unit 23.

The light scanning unit 21 scans light corresponding to the print data onto the photosensitive medium 22, and may include a laser scanning unit to scan light generated by a laser diode to the photosensitive medium 22.

A charging member (not illustrated) charges a surface of the photosensitive medium 22 with a predetermined voltage. The light generated by the light scanning device 21 forms electrostatic latent images corresponding to the print data on the surface of the photosensitive medium 22. In this embodiment, a photosensitive drum is used as the photosensitive medium 22. The photosensitive medium 22 may be disposed integrally with the developing unit 23.

The developing unit 23 stores a predetermined amount of developer, and supplies the photosensitive medium 22 with developer so as to develop electrostatic latent images formed on the surface of the photosensitive medium 22 into developer images. In this embodiment, the developing units 23 of the four main developing apparatuses 20 supply yellow, cyan, magenta, and black (Y, C, M, K) developer to the photosensitive media 22 so as to form images developed by corresponding colors, respectively. Therefore, the four main developing apparatuses 20 can form full color images.

When the four main developing apparatuses 20 form a color image on a printing medium 300, a first color developer may be transferred onto the printing medium 300, and then a second color developer may be overlapped on and/or near the transferred first color developer so that a predetermined color image may be formed. For example, cyan developer dots may be transferred on and/or near yellow developer dots formed on the printing medium 300 by yellow developer so as to turn a portion of the printing medium 300 green in color. That is, two or more among the four color developers may be combined to form a different color image than an image formed with the four main colors. Therefore, since more than one color developer may be used to form a different color, to form color images using the four color developers may use a larger amount of developer than to form images using the mono developer.

One or a plurality of auxiliary developing apparatuses 30 may form additional images on the printing medium 300 in addition to the images formed by the plurality of main developing apparatuses 20. In this embodiment, at least two auxiliary developing apparatuses 30 are used to form images such as white (W) images and transparent (T) images. The auxiliary developing apparatus 30 includes a light scanning unit 31, a photosensitive medium 32, and a developing unit 33 similar to the main developing apparatuses 20 as described above. The auxiliary developing apparatuses 30 may be different from the main developing apparatuses 20 in the manner the auxiliary developing apparatuses use developer.

The auxiliary developing apparatus 30 can use various kinds of developers in combination with the above-described four color developers used to form full color images. For example, the auxiliary developing apparatus 30 can use one developer among white, transparent, and a light color category of developers as a developer. The light color category developer may include light cyan developer or light magenta developer, for example, or other of the four main colors may be used in a light version.

The white developer may be used to visually lighten the colors of the four color developers used by the main developing apparatuses 20. Also, the white developer may be used to provide a specific surface effect, such as special patterns, the feel of a material, brilliance, etc., upon regions of the printing medium 300 except regions of the printing medium 300 printed by the four color developers. The white developer may also be used to remove stains from the surface of the printing medium 300.

The transparent developer may be used for purposes similar to the usage of the white developer. In addition, the transparent developer may be used to form a transparent image to be overlapped on the color image formed by the four color developers, thereby protecting the color image.

Furthermore, the developers in the light color category may be used to soften the colors presented by the four color developers of the main developing apparatuses 20. The light color category developers may be used to provide a specific surface effect, such as special patterns, the feel of a material, brilliance, etc., upon regions of the printing medium 300 except regions of the printing medium 300 printed by the four color developers similarly to the white color.

Therefore, when the white developer, the transparent developer, or the light color category developers are used to print, the usage amount of a total of all developers may be much larger than when only the four color developers are used to print. In other words, when a printing operation is performed using one or a combination of the white, transparent, or light color category developer, the printing coverage of the printing medium 300 may rapidly be increased. The amount of the developer used when color images are formed using the four color developers may be up to twice as much or more as that used when mono images (for example, black images) are formed using a mono color developer (for example, black developer). Also, the amount of the developer used when color images are formed using five or more color developers (for example, the four color developers and white, transparent developer, or light color category) may be much larger than that used when the four color developers are used.

The printing media conveying unit 40 fixes and conveys the printing medium 300 fed from the printing medium feeding unit 10. The printing media conveying unit 40 allows the printing medium 300 to pass by a side of the photosensitive medium 22 of each of the plurality of main developing apparatuses 20 and by a side of the photosensitive medium 32 of the auxiliary developing apparatus 30. The printing media conveying unit 40 may include a conveying belt 41 and a plurality of rollers 43 to cause the conveying belt 41 to perform an endless orbiting motion. When the printing medium 300 is passed by a side of the photosensitive medium 22 of each of the four main developing apparatuses 20 by the printing media conveying unit 40, developer images on the four photosensitive media 22 are transferred onto the printing medium 300 so as to form a full color image. An image or images formed by one or more of the four color developers may be formed to overlap with, or be formed near, an image or images formed by another of the four color developers. Also, when the printing medium 300 passes a side of the photosensitive medium 32 of the auxiliary developing apparatus 30, the auxiliary developing apparatus 30 supplies auxiliary developer to form a specific image on the printing medium 300 already acted on by one or more of the other developers.

The plurality of transfer media 50 allows the developer images formed on the photosensitive media 22 of the plurality of main developing apparatuses 20 and the photosensitive medium 32 of the auxiliary developing apparatus 30 to be transferred onto the printing medium 300 conveyed by the printing media conveying unit 40. In this embodiment, the plurality of transfer media 50 is disposed inside the conveying belt 41 of the printing media conveying unit 40 at positions corresponding to the photosensitive media 22 of the plurality of main developing apparatuses 20 and the photosensitive medium 32 of the auxiliary developing apparatus 30.

The fusing unit 60 causes the developer images transferred, when the printing medium 300 passes by the plurality of photosensitive media 22 and 32, to be fixed on the printing medium 300. To this end, the fusing unit 60 is formed to apply heat and pressure to the printing medium 300. The fusing device 60 may be formed in various types, such as a roller type, a belt type, a film type, etc. In this embodiment, as illustrated in FIG. 1, the roller type fusing device 60 is used.

In the image forming apparatus 1 according to this embodiment, as illustrated in FIG. 1, the auxiliary developing apparatuses 30 are disposed downstream of the four main developing apparatuses 20, and the fusing unit 60 is disposed downstream of the auxiliary developing apparatus 30. Alternatively, although not illustrated, the auxiliary developing apparatus 30 may be disposed downstream of the fusing unit 60. That is, the image forming apparatus 1 may be formed so that after the fusing unit 60 fixes the images formed by the four main developing apparatuses 20 on the printing medium 300, the auxiliary developing apparatus 30 forms an additional image on the printing medium 300. In this case, the image forming apparatus 1 may be required to have an auxiliary fusing unit (not illustrated) to fix the additional image formed by the auxiliary developing apparatus 30.

The discharging unit 70 conveys the printing medium 300 on which images have been fixed during passage through the fusing unit 60 to the processing apparatus 5 disposed at a side of the main case 3.

The control portion 100 controls the printing medium feeding unit 10, the plurality of main developing apparatuses 20, the auxiliary developing apparatus 30, the printing media conveying unit 40, the plurality of transfer media 50, the fusing unit 60, and the discharging unit 70 to form the images on the printing medium 300 and conveys the printing medium 300 to the processing apparatus 5. The control portion 100 may be connected to the host 200 such as a personal computer, an input/output portion 103, and the processing apparatus 5. The input/output portion 103 may include a display portion to inform the user of a state of the image forming apparatus 1 and the input portion which the user uses to input control commands with respect to the image forming apparatus 1.

Referring to FIG. 2, the control portion 100 may include a main control portion 101, a processing position-calculating portion 104, a processing control portion 105, and a memory 102.

When a print command and print data are received, for example, from the host 200, the main control portion 101 controls the printing medium feeding unit 10, the plurality of main developing apparatuses 20, the auxiliary developing apparatus 30, the print media conveying unit 40 the plurality of transfer media 50, and the fusing unit 60 to form images corresponding to the received print data on the printing medium 300.

The processing control portion 105 controls the processing apparatus 5 according to signals from the main control portion 101 to perform a processing operation, such as binding, folding, stapling, punching, etc., with respect to the printing medium 300.

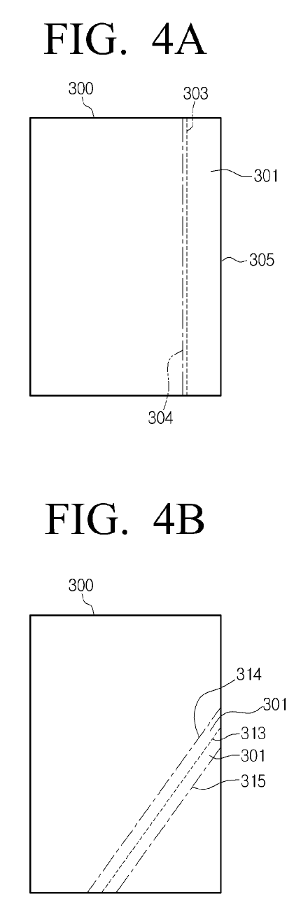

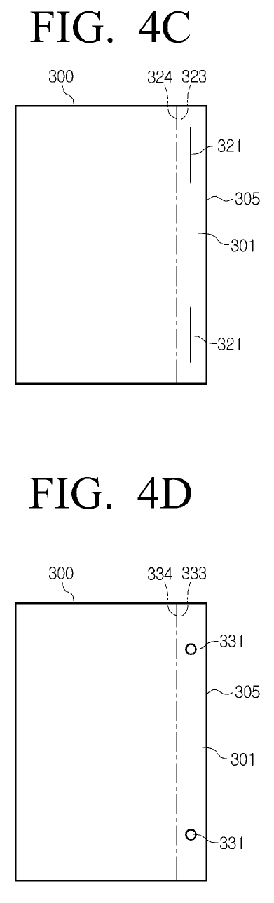

Before the processing operation of the printing media 300 is performed, the processing position-calculating portion 104 calculates a region of the printing medium 300 at which the processing operation is going to be performed, that is, a processing region 301 of the printing medium 300 (see FIGS. 4A to 4D) and sends calculated results to the main control portion 101.

The memory 102 stores processing conditions and various data that the control portion 100 may use in order to control the image forming apparatus 1 to form the images on the printing medium 300.

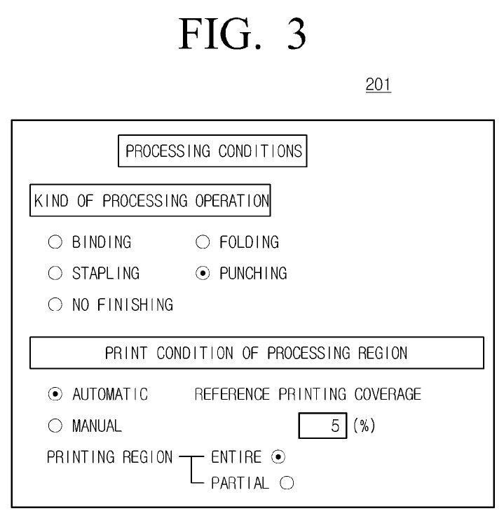

The processing conditions may include the kinds of processing operations, and printing conditions of the processing region 301. The processing conditions may be inputted via the input/output portion 103 of the image forming apparatus 1 or other source such as external memory. Also, the processing conditions may be inputted using the host 200 connected with the image forming apparatus 1. The inputted processing conditions may be stored in the memory 102 of the control portion 100. The host 200 may have an image forming apparatus control program to control the image forming apparatus 1. The image forming apparatus control program may display a processing conditions selecting menu 201 as illustrated in FIG. 3 on a display unit (not illustrated) of the host 200.

Referring to FIG. 3, the user can select one among ‘binding’, ‘folding’, ‘stapling’, ‘punching’, and ‘no processing’ in the Kind of Processing Operation of the Processing Conditions selecting menu 201 displayed on the display unit of the host 200. After the kind of the processing is selected, the processing apparatus 5 performs the selected processing operation. FIG. 3 illustrates the processing conditions selecting menu 201 on which ‘punching’ is selected as the processing operation. When ‘punching’ is selected as the processing condition, the processing apparatus 5 performs a punching operation with respect to the printing medium 300 having been printed. Alternatively, when ‘no processing’ is selected, the processing apparatus 5 does not perform any processing operation with respect to the printing medium 300. The processing operations may be performed regarding a single page of printing medium, or a plurality of pages of printing media, depending on the desired processing condition.

Referring to FIG. 3, the user can further select either ‘automatic’ or ‘manual’ in a Print Condition of the Printing Medium Processing Region sub-menu of the processing conditions selecting menu 201. FIG. 3 illustrates the processing conditions selecting menu 201 on which ‘automatic’ is selected as the print condition. The ‘automatic’ means an automatic printing mode, and the ‘manual’ means a manual printing mode. As used herein, the printing coverage means the percentage of an area of a region which the images are to be formed compared to an entire area of one printing medium 300. When ‘automatic’ is selected, the main control portion 101 compares a printing coverage of an image that is going to be printed on the printing medium 300 with a reference printing coverage. If the printing coverage of the image that is going to be printed on the printing medium 300 is larger than the reference printing coverage, the main control portion 101 controls the auxiliary developing apparatus 30 not to form the additional image on the processing region 301 of the printing medium 300. However, if the printing coverage of the image that is going to be printed on the printing medium 300 is the same as or smaller than the reference printing coverage, the main control portion 101 controls the auxiliary developing apparatus 30 to form the additional image on the processing region 301 of the printing medium 300.

Here, the processing region 301 of the printing medium 300, as illustrated in FIGS. 4A to 4D, indicates regions or positions of the printing medium 300 at which the processing apparatus 5 performs one or more tasks among binding, folding, stapling, and punching,. That is, the processing region 301 represents the region of the printing medium 300 at which the processing operation is performed. The auxiliary developing apparatus 30 can selectively form an auxiliary developer image on the processing region 301 at which the processing operation is performed.

FIG. 4A illustrates a printing medium 300 that may be bound. A dotted line 303 represents a line at which the printing medium 300 may be bound. A region 301 from an alternated long and short dash line 304 at a side of the dotted line 303 (for example, the left side of the dotted line 303 in FIG. 4A) to a side end 305 of the printing medium 300 (for example, the right side of the dotted line 303 in FIG. 4A) represents the processing region 301 on which the auxiliary developing apparatus 30 may form an image or not.

FIG. 4B illustrates a printing medium 300 that may be folded. A dotted line 313 represents a line at which the printing medium 300 may be folded. A region 301 between two alternated long and short dash lines 314 and 315 at both sides of the dotted line 313 represents the processing region 301 on which the auxiliary developing apparatus 30 may form an image or not.

FIG. 4C illustrates a printing medium 300 that may be stapled and folded. A dotted line 323 represents a line at which the printing medium 300 may be folded. A region 301 in which there are two staples 321 between an alternated long and short dash line 324 at a side of the dotted line 323 (for example, the left side of the dotted line 323 in FIG. 4C) and a side end 305 of the printing medium 300 (for example, the right side of the dotted line 323 in FIG. 4C) represents the processing region 301 of the printing medium 300 on which the auxiliary developing apparatus 30 may form an image or not.

FIG. 4D illustrates a printing medium 300 that is punched and folded. A dotted line 333 represents a line at which the printing medium 300 may be folded. A region 301 at which there are two punching holes 331 between an alternated long and short dash line 334 at a side of the dotted line 333 (for example, the left side of the dotted line 333 in FIG. 4D) and a side end 305 of the printing medium 300 (for example, the right side of the dotted line 333 in FIG. 4D) represents the processing region 301 of the printing medium 300 on which the auxiliary developing apparatus 30 may form an image or not.

As stated previously, the printing coverage means the percentage of an area of a region which the images are to be formed compared to an entire area of one printing medium 300. For example, when the entire area of one printing medium 300 is printed, the printing coverage is 100% (percent). Therefore, the larger the printing coverage is, the larger the amount of developer used. For general printing matters in which the printing medium 300 may have general images formed thereon, a printing medium 300 may have a printing coverage of approximately 5%. Therefore, when the printing coverage is over 5%, the printing medium 300 may be referred to have a high printing coverage. When the printing coverage is less than 5%, the printing medium 300 may be referred to have a low printing coverage.

The user can arbitrary set a reference printing coverage in the processing conditions selecting menu 201 as illustrated in FIG. 3. The printing coverage of 5% that is the printing coverage of general printed matters may be used as the reference printing coverage. When the user does not set the reference printing coverage, the main control portion 101 may set a general printing coverage stored in the memory 102 as the reference printing coverage.

When in the processing conditions selection menu 201 and ‘manual’ is selected, that is, the manual printing mode is selected, the main control portion 101 compares the printing coverage of an image that is going to be printed on the printing medium 300 with the reference printing coverage. If the printing coverage of the image that is going to be printed is larger than the reference printing coverage, the main control portion 101 may output a selecting signal so that the user can determine whether to allow the main control portion 101 to form the image on the processing region 301. As a result, the main control portion 101 may generate a warning signal and display a message on which the user can use the input/output portion 103 to select whether to allow the image to be formed on the processing region 301 of the printing medium 300. Also, the main control portion 101 may output the same message on the display unit of the host 200 connected with the image forming apparatus 1. However, if the printing coverage of the image that is going to be printed on the printing medium 300 is the same as or smaller than the reference printing coverage, the main control portion 101 does not output the selecting signal, and directly forms the image on the processing region 301.

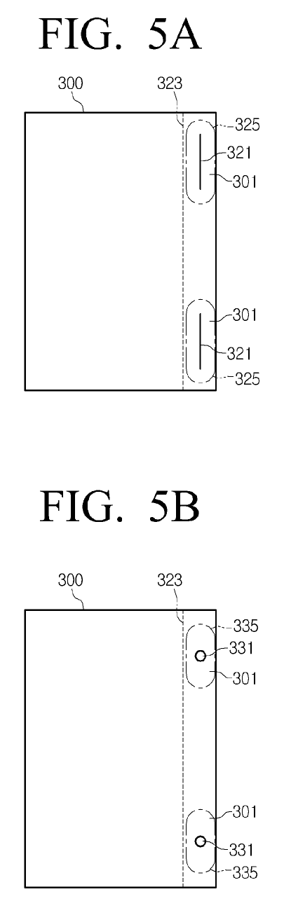

Also, the user can select ‘printing region’ in the processing conditions selecting menu 201. The printing region can be selected only when the stapling operation or the punching operation was selected as the processing operation. FIG. 3 illustrates the processing conditions selecting menu 201 on which ‘entire’ is selected as the printing region. When ‘entire’ is selected, the entire region of the processing region 301 at which the stapling or punching operation is performed as illustrated in FIGS. 4C and 4D is set as a non-image area on which the auxiliary developing apparatus 30 does not form images. When the ‘partial’ is selected, only the regions around the staples 321 (the region surrounded by an alternated long and short dash line 325) or the regions around the punching holes 331 (the region surrounded by an alternated long and short dash line 335) as illustrated in FIGS. 5A and 5B is set as the non-image area on which the auxiliary developing apparatus 30 does not form images.

The processing apparatus 5 may be disposed at an upper portion of the main case 3 of the image forming unit 2, and performs a processing operation with respect to the printing medium 300 discharged from the discharging unit 70. The processing apparatus 5 may be formed to perform at least one operation among binding, folding, stapling, and punching operations. The inner structure of the processing apparatus 5 is not illustrated in FIG. 1. FIG. 1 illustrates the image forming apparatus 1 to have the processing apparatus 5 disposed or located at or near the upper portion of the main case 3. However, this is only one example and does not limit the position at which the processing apparatus 5 can be disposed or located. The processing apparatus 5 may be disposed or located at or near one of the sides of the main case 3 parallel to the main case 3 according to the structure and size of the processing apparatus 5.

Hereinafter, operation of the image forming apparatus 1 to have the processing apparatus 5 with the structure as described above will be explained with reference to FIGS. 1 and 2.

First, the user selects the processing conditions of the image forming apparatus 1 using the processing conditions selecting menu 201 outputted on the display unit of the host 200. Alternatively, the user can input the processing conditions using the input/output portion 103 of the image forming apparatus 1 or, processing conditions may be inputted by external memory devices. The user can select the kind of processing operation as the processing condition. In other words, the user can select one among binding, folding, stapling, and punching operations as the processing operation. If the processing operation is not needed, the user can select no processing. Also, the user can select either automatic or manual with respect to the printing of the processing region 301 of the printing medium 300. If necessary, the user can set the reference printing coverage.

When a printing order and print data are received from the host 200, the main control portion 101 of the control portion 100 controls the printing medium feeding unit 10 to pick up a printing medium 300 and to feed it to the printing media conveying unit 40.

Simultaneously, the main control portion 101 calculates a printing coverage of an image that is going to be printed, and compares the calculated printing coverage with the reference printing coverage stored in the memory 102. If the printing coverage of the image that is going to be printed is larger than the reference printing coverage, the main control portion 101 reads which processing operation is selected from the processing conditions stored in the memory 102, and orders the processing position-calculating portion 104 to estimate a size or area of a region of the printing medium 300 at which the processing operation is performed, that is, the processing region 301. Then, the processing position-calculating portion 104 estimates the size or area of the processing region 301 of the printing medium 300 and sends it to the main control portion 101.

The main control portion 101 controls the four main developing apparatuses 20 to form a color image corresponding to the print data. That is, the light scanning device 21 of each of the main developing apparatuses 20 scans light to form an electrostatic latent image corresponding to the print data on the each photosensitive medium 22. Then, each developing unit 23 supplies each color developer to develop the electrostatic latent image formed on the each photosensitive medium 22 into a developer image.

Also, the main control portion 101 controls the auxiliary developing apparatus 30 to form an image corresponding to the print data on the photosensitive medium 32 of the auxiliary developing apparatus 30. If the printing coverage of the image that is going to be printed is larger than the reference printing coverage, the main control portion 101 controls the auxiliary developing apparatus 30 not to form an auxiliary developer image on the estimated region of the printing medium 300 at which the processing operation is performed, that is, the estimated size or area of the processing region 301 as illustrated in FIGS. 4A to 4D and FIGS. 5A and 5B. In this embodiment, for the auxiliary developing apparatus 30 not to form the auxiliary image on the estimated size or area of the printing medium processing region 301, the main control portion 101 does not control the light scanning device 31 of the auxiliary developing apparatus 30 to form the electrostatic latent image on the corresponding region of the photosensitive medium 32.

The developer image formed on the photosensitive medium 22 of each of the four main developing apparatuses 20 may be overlappingly transferred onto the printing medium 300, which is conveyed at a side of the each photosensitive medium 22 by the printing media conveying unit 40, by the transfer medium 50 to form a color image. Also, the auxiliary developer image formed on the photosensitive medium 32 of the auxiliary developing apparatus 30 disposed downstream of the four main developing apparatuses 20 is transferred onto the printing medium 300 having the color developer image transferred thereon. At this time, there is no auxiliary image on a region of the photosensitive medium 32 of the auxiliary developing apparatus 30 corresponding to the estimated size or area of the processing region 301 of the printing medium 300 so that the auxiliary developer image is not formed on the estimated size or area of the processing region 301.

However, if the printing coverage of the image that is going to be printed is the same as or smaller than the reference printing coverage, the main control portion 101 controls the four main developing apparatuses 20 and the auxiliary developing apparatus 30 to form the image on the entire region of the printing medium 300 including the processing region 301.

When the printing medium 300 passes by the fusing unit 60, the developer image having been transferred on the printing medium 300 is fixed on the printing medium 300 by heat and pressure of the fusing unit 60. The printing medium 300 having the image fixed thereon enters the processing apparatus 5 disposed at a side of the main case 3 via the discharging unit 70.

When the printing medium 300 enters, the processing control portion 105 controls the processing apparatus 5 to perform a processing operation with respect to the printing medium 300 according to the kind of processing operation stored in the memory 102. In some instances, since there is no auxiliary developer image formed by the auxiliary developing apparatus 30 on the processing region 301 of the printing medium 300 at which the processing apparatus 5 performs the processing operation, the usage amount of auxiliary developer can be reduced. When there is no image on the processing region 301 of the printing medium 300, a cutter used in the punching operation may be prevented from being stained. If the cutter used in the punching operation is severely stained, the cutter used in the punching operation becomes dull and the punching operation is not performed clearly. Therefore, the cutter used in the punching operation may be required to be replaced. The replacement of the cutter would be an undesired expense that would cost the printing effort time and money. Also, in case that the stapling operation is performed, when the image is formed on the processing region 301, some of the developer to form the image on the processing region 301 may be attached to a stapling device of the processing apparatus 5. Then, the developer attached to the stapling device may unnecessarily stain a next printing medium 300 to which the next stapling operation is performed. However, if no image is formed on the processing region 301 of the printing medium 300, these problems do not occur.

In the above description, the image forming apparatus 1 is formed so that the images formed on the plurality of photosensitive media 22 and 32 are directly transferred onto the printing medium 300 conveyed by the printing media conveying unit 40. However, this does not limit the structure of the image forming apparatus 1 to which the present general inventive concept can be applied. The present general inventive concept can be applied to various image forming apparatuses 1 that are constituted to form images using a photosensitive drum, a photosensitive belt, an intermediate transfer belt, etc. Also, the present general inventive concept can be applied to various image forming apparatuses to form images using five or more color developers.

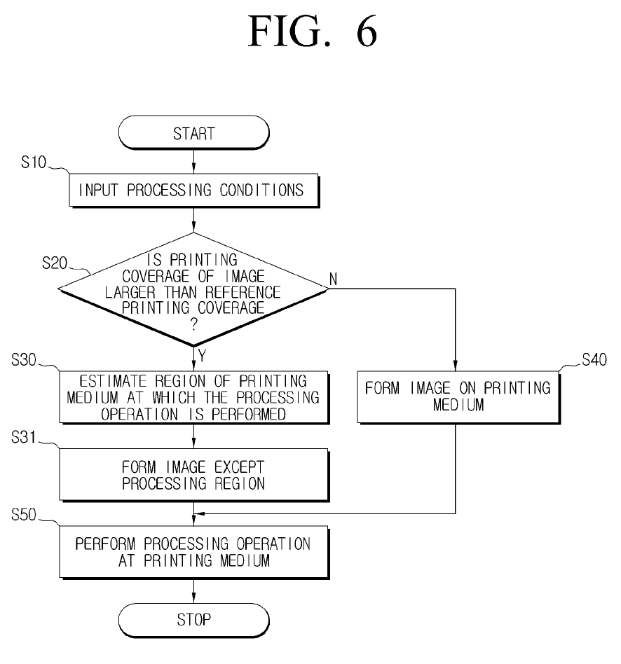

Hereinafter, a processing method of an image forming apparatus according to an embodiment of the present general inventive concept will be explained with reference to FIGS. 1, 2, and 6.

The user inputs the processing conditions using the input/output portion 103 of the image forming apparatus 1 or the host 200 (S10). The inputted processing conditions are stored in the memory 102 of the control portion 100. The kind of processing operation and the print condition of the printing medium processing region 301 may be selected as the processing conditions.

The control portion 100 of the image forming apparatus 1 calculates the printing coverage of the image that is going to be printed using the print data received from the host 200. Then, the control portion 100 compares the calculated printing coverage with the reference printing coverage stored in the memory 102 (S20).

If the printing coverage of the image that is going to be printed is larger than the reference printing coverage, the main control portion 101 determines the selected processing operation, and causes the processing position-calculating portion 104 to estimate a size or area of a region of the printing medium 300 at which the processing operation is performed, that is, the processing region 301 of the printing medium 300 (S30). The processing region 301 is not of a fixed size, but may vary depending on the type of processing operation required, or other printing operations.

Also, the main control portion 101 determines whether the selected print condition of the processing region 301 is an automatic printing mode or a manual printing mode.

If the print condition of the processing region 301 is selected as the automatic, the control portion 100 controls the plurality of main developing apparatuses 20 to form an image corresponding to the print data on the printing medium 300, and controls the auxiliary developing apparatus 30 to form the image on the printing medium 300 except the processing region 301 (S31).

If the print condition of the processing region 301 is selected as the manual, the control portion 100 may output a message through the input/output portion 103 of the image forming apparatus 1 so that the user can select whether to allow the main control portion 101 to form the image on the processing region 301 or not. Also, the main control portion 101 may output the message on the display unit of the host 200. The message may include a way through which the user can select whether to allow the image to be formed on the processing region 301.

If the user selects the image to be formed on the processing region 301, the main control portion 101 controls the auxiliary developing apparatus 30 to form the image on the processing region 301 of the printing medium 300. If the user does not select the image to be formed on the processing region 301, the main control portion 101 does not control the auxiliary developing apparatus 30 to form the image on the processing region 301.

After the printing operation is complete, the main control portion 101 supplies the printing medium 300 to the processing apparatus 5 and orders the processing control portion 105 to perform the selected processing operation. Then, the processing control portion 105 controls the processing apparatus 5 to perform the selected processing operation with respect to the printing medium 300 (S50).

On the other hand, if the printing coverage of the image that is going to be printed is the same as or smaller than the reference printing coverage, the main control portion 101 controls the plurality of main developing apparatuses 20 to form the image corresponding to the print data on the printing medium 300. After that, the main control portion 101 controls the auxiliary developing apparatus 30 to form the image on the entire region of the printing medium 300 including the processing region 301 (S40). When the printing coverage of the image that is going to be printed is the same as or smaller than the reference printing coverage, the main control portion 101 does not perform the process to estimate a size or area of a region of the printing medium 300 at which the processing operation is performed.

After the printing operation is complete, the main control portion 101 supplies the printing medium 300 to the processing apparatus 5 and orders the processing control portion 105 to perform the selected processing operation. Then, the processing control portion 105 controls the processing apparatus 5 to perform the selected processing operation with respect to the printing medium 300 (S50).

The image forming apparatus 1 may also receive input data as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

In the above description, a processing operation, such as binding, punching, stapling, folding operations, etc, is performed on a printing medium after at least one image was formed on the printing medium. However, this does not limit the present general inventive concept. The processing operation may be performed on the printing medium before at least one image is formed on the printing medium.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents

What is claimed is:

1. An image forming apparatus to have a processing apparatus, comprising:
a plurality of main developing apparatuses to form a first image on a printing medium;
an auxiliary developing apparatus to form an additional image on the printing medium using at least one developer different from developers used in the plurality of main developing apparatuses;
a processing apparatus to perform a processing operation on the printing medium; and
a control portion to control the main developing apparatuses and the auxiliary developing apparatus to form selectively the first image and the additional image on the printing medium and to control the processing apparatus to form a processing region on the printing medium at which the processing operation is performed;
wherein the control portion controls the auxiliary developing apparatus to not form the additional image on at least some region around the processing region.

2. The image forming apparatus of claim 1, wherein the processing condition comprises a printing coverage.

3. The image forming apparatus of claim 2, wherein if the printing coverage of the image that is going to be printed is larger than a reference printing coverage, the control portion controls the auxiliary developing apparatus to not form the image on the processing region, and
if the printing coverage of the image that is going to be printed is the same as or smaller than the reference printing coverage, the control portion controls the auxiliary developing apparatus to form the image on the processing region.

4. The image forming apparatus of claim 1, wherein the auxiliary developing apparatus forms white images, light color images or transparent images.

5. The image forming apparatus of claim 1, wherein the processing apparatus is formed to perform at least one operation among binding, folding, stapling, and punching operations.

6. The image forming apparatus of claim 5, wherein the processing region is a region of the printing medium at which the processing apparatus performs at least one operation among the binding, folding, stapling, and punching operations.

7. The image forming apparatus of claim 1, wherein when the image is not formed on the processing region, the control portion controls a light scanning device of the auxiliary developing apparatus to not form an electrostatic latent image on a region of a photosensitive medium corresponding to the processing region.

8. A processing method for an image forming apparatus to have a processing apparatus, comprising:
receiving an input of a processing condition;
comparing a printing coverage of an image that is going to be printed with a reference printing coverage;
estimating if the printing coverage of the image that is going to be printed is larger than the reference printing coverage a size or area of a processing region of a printing medium at which the inputted processing operation is to be performed;
forming the image on the printing medium except the processing region; and
performing the processing operation on the printing medium.

9. The processing method of claim 8, wherein if the printing coverage of the image that is going to be printed is the same as or smaller than the reference printing coverage, the processing method further comprises;
forming the image on the printing medium; and
performing the processing operation on the printing medium.

10. The processing method of claim 8, wherein the receiving the input of the processing condition comprises:
inputting the processing condition through an input/output portion of the image forming apparatus or inputting the processing condition through a host connected with the image forming apparatus.

11. The processing method of claim 8, wherein the processing condition comprises binding, folding, stapling, and punching operations as the kind of the processing operation.

12. The processing method of claim 8, wherein the processing condition comprises an automatic print mode and a manual print mode as a print condition of the processing region.

13. The processing method of claim 12, wherein if the manual print mode is set in a print condition, when the printing coverage of the image that is going to be printed is larger than the reference printing coverage, a user selects whether to allow the image to be formed on the processing region.

14. The processing method of claim 11, wherein when the processing condition is at least one among the stapling or punching operation, a print condition of the processing region comprises that the image is not formed on a partial region of the processing region.

15. An image forming apparatus, comprising:
a main developing apparatus to form a first image on a printing medium;
an auxiliary developing apparatus to form an additional image on the printing medium;
a processing apparatus to perform processing operations on the print medium;
a processing region on the print medium in which to perform the processing operations; and
a control portion to output a selecting signal if a mode is selected so that a user can determine whether to allow the control portion to form the additional image on the processing region.

16. The image forming apparatus of claim 15, wherein processing operations include binding, folding, stapling, and punching operations.

17. A method of forming an image in an image forming apparatus, comprising:
receiving an input of a processing condition to be processed on a printing medium;
receiving an input of an image to be printed on a printing medium;
comparing a size of a printing coverage of the image to be printed on the printing medium with a size of a reference printing coverage; and
controlling the developing of the image on a processing region based on the result of the comparison between the size of the printing coverage and the size of the reference printing coverage.

18. The method of claim 17, wherein if the size of the printing coverage is larger than the reference printing coverage, the image is not developed on the processing region.

19. The method of claim 17, wherein if the size of the printing coverage is the same as or smaller than the reference printing coverage, the image is developed on the processing region.

20. A computer readable medium to contain computer-readable codes as a program to perform a method in an image forming apparatus to have a processing apparatus, the method comprising:
receiving an input of a processing condition;
comparing a printing coverage of an image that is going to be printed with a reference printing coverage;
estimating if the printing coverage of the image that is going to be printed is larger than the reference printing coverage a size or area of a processing region of a printing medium at which the inputted processing operation is to be performed;
forming the image on the printing medium except the processing region; and
performing the processing operation on the printing medium.
